(19) United States
(12) Patent Application Publication
(10) Pub. No.: US 2015/0269330 A1
(43) Pub. Date: Sep. 24, 2015

(54) INFORMATION MANAGEMENT SYSTEM AND METHOD

(71) Applicant: IntelaTrak, Inc., Henniker, NH (US)

(72) Inventors: MICHAEL LYONS, Henniker, NH (US); William R. Brown, Henniker, NH (US)

(21) Appl. No.: 14/663,306

(22) Filed: Mar. 19, 2015

Related U.S. Application Data
(60) Provisional application No. 61/955,533, filed on Mar. 19, 2014.

(51) Int. Cl. G06F 19/00

(52) U.S. Cl. CPC G06F 19/327

(57) ABSTRACT

A method, computer program product, and computing system for associating a scannable tag with a healthcare consumable of a medical patient. Escalating reminders are provided to a medical professional, the escalating reminders concerning a medical procedure to be performed on the healthcare consumable by the medical professional. Identifying indicia that is obtained by the medical professional scanning the scannable tag with a client electronic device is received, thus defining an identified healthcare consumable. Status update information that concerns the identified healthcare consumable is received from the client electronic device.

### RELATED APPLICATION

This application claims the benefit of U.S. Provisional Application No. 61/955,533, filed on 19 Mar. 2014 and entitled “SCHEDULING, TRACKING AND NOTIFICATION SYSTEM”, the contents of which is incorporated by reference.

### TECHNICAL FIELD

This disclosure relates to information management systems and, more particularly, to information management systems for use within the medical field.

### BACKGROUND

People in the medical field are often required to perform tasks that may require supervision, guidance or assistance. For example, medical service technicians may be required to perform maintenance/repair procedures on medical devices & systems that they may not be familiar with. Further, medical diagnostic staff may be required to perform operations & procedures using such medical devices & systems whose operation they may not be familiar with. Further, medical professionals may need to perform such medical procedures on medical patients, where the performance and timing of these medical procedures may need to be documented in order to confirm adherence to various procedures/protocols. Additionally and after release from a medical facility, these medical patients may need to perform rudimentary medical procedures on themselves, wherein the medical patients may not understand the proper way to perform such medical procedures.

### SUMMARY OF DISCLOSURE

In one implementation, a computer-implemented method is executed on a computing system. The computer-implemented method includes associating a scannable tag with a healthcare consumable on a medical patient. Escalating reminders are provided to a medical professional, the escalating reminders concerning a medical procedure to be performed on the healthcare consumable by the medical professional. Identifying indicia that is obtained by the medical professional scanning the scannable tag with a client electronic device is received, thus defining an identified healthcare consumable. Status update information that concerns the identified healthcare consumable is received from the client electronic device.

One or more of the following features may be include. The status update information may include one or more of: a task completion confirmation concerning the identified healthcare consumable; a pain assessment concerning the identified healthcare consumable; and visual information concerning the identified healthcare consumable. Providing escalating reminders to a medical professional may include: providing a first level reminder to the medical professional; determining whether the medical professional responded to the first level reminder; and if the medical professional did not respond to the first level reminder, providing a second level reminder to the medical professional. Providing escalating reminders to a medical professional may further include: determining whether the medical professional responded to the second level reminder; and if the medical professional did not respond to the second level reminder, providing a third level reminder to the medical professional. The first level reminder may have a first level of urgency and involves a first list of recipients; the second level reminder may have a second level of urgency and involves a second list of recipients; and the third level reminder may have a third level of urgency and involves a third list of recipients. The escalating reminders may have escalating levels of urgency. The scannable tag may include one or more of: an optically scannable tag; and an electronically scannable tag.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an information management process coupled to a distributed computing network;

FIG. 2 is a diagrammatic view of various aspects of the information management process of FIG. 1;

FIG. 3 is a flow chart of one implementation of the information management process of FIG. 1;

FIG. 4 is a diagrammatic view of various aspects of the information management process of FIG. 1; and

FIG. 5 is a flow chart of another implementation of the information management process of FIG. 1.

Like reference symbols in the various drawings indicate like elements.

### DETAILED DESCRIPTION OF THE PREFERRED EMBODIMENTS

### System Overview:

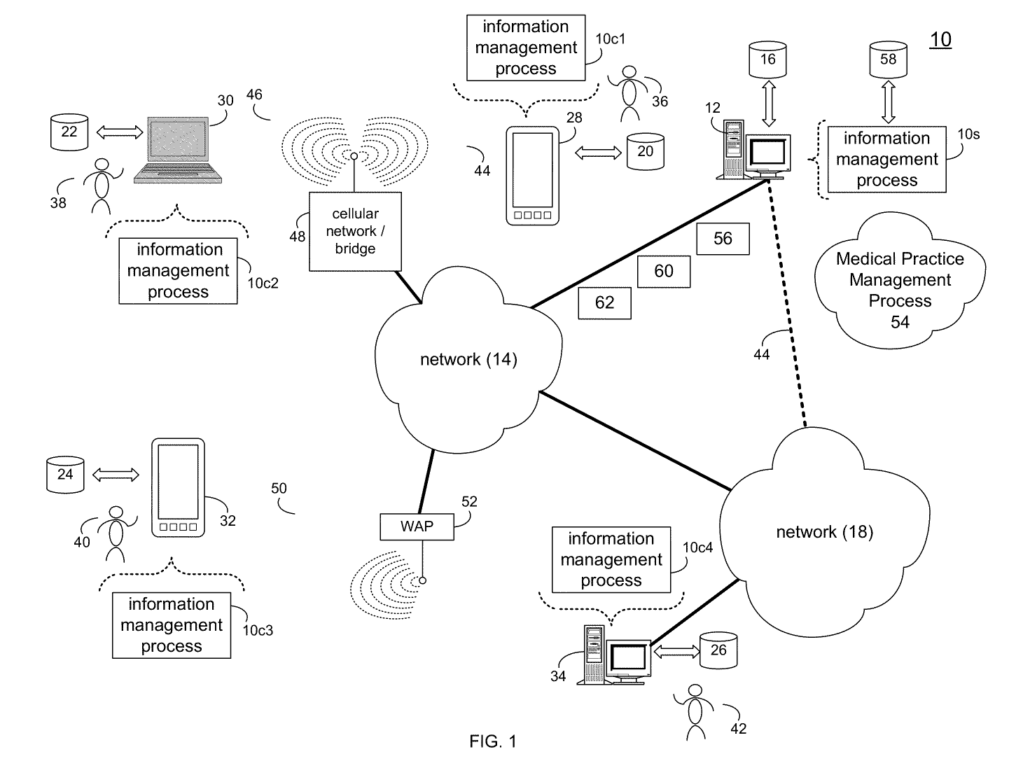

In FIG. 1, there is shown information management process 10. As will be discussed below in greater detail, information management process 10 may be configured to provide topic-specific information concerning the performance of procedures within the medical field, examples of which may include but are not limited to medical device maintenance & use and the performance of various medical procedures. Information management process 10 may also be configured to document the performance of these procedures and to provide various levels of reminders concerning the same.

Information management process 10 may be implemented as a server-side process, a client-side process, or a hybrid server-side/client-side process. For example, information management process 10 may be implemented as a purely server-side process via information management process 10s. Alternatively, information management process 10 may be implemented as a purely client-side process via one or more of information management process 10c1, information management process 10c2, information management process 10c3, and information management process 10c4. Alternatively still, information management process 10 may be implemented as a hybrid server-side/client-side process via information management process 10s in combination with one or more of information management process 10c1, information management process 10c2, information management process 10c3, and information management process 10c4. Accordingly, information management process 10 as used in this disclosure may include any combination of information management process 10s, information management process 10c1, information management process 10c2, information management process 10c3, and information management process 10c4.

Information management process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a smartphone, a notebook computer, a television with one or more processors embedded therein or coupled thereto, a server computer, a series of server computers, a mini computer, a mainframe computer, or a dedicated network device.

The instruction sets and subroutines of information management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of information management processes 10c1, 10c2, 10c3, 10c4 may include but are not limited to a web browser, a game console user interface, a social network user interface, or a specialized applet/application. The instruction sets and subroutines of information management processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, smartphone/tablet 28, laptop computer 30, smartphone/tablet 32, personal computer 34, a personal digital assistant (not shown), a notebook computer (not shown), a server computer (not shown), a smart television (not shown), a gaming console (not shown), a custom wireless device (not shown) and a dedicated network device (not shown). Client electronic devices 28, 30, 32, 34 may each execute an operating system.

Users 36, 38, 40, 42 may access information management process 10 directly through network 14 or through secondary network 18. Further, information management process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, smartphone/tablet 28 and laptop computer 30 are shown wirelessly coupled to network 14 via wireless communication channels 44, 46 (respectively) established between smartphone/tablet 28, laptop computer 30 (respectively) and cellular network/bridge 48, which is shown directly coupled to network 14. Further, smartphone/tablet 32 is shown wirelessly coupled to network 14 via wireless communication channel 50 established between smartphone/tablet 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between smartphone/tablet 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Information Management Process:

As discussed above, information management process 10 may be configured to provide topic-specific information concerning the performance of procedures within the medical field, examples of which may include but are not limited to medical device maintenance & use and the execution of various medical procedures. Information management process 10 may also be configured to document the performance of these procedures and to provide various levels of reminders concerning the same. Information management process 10 may be included within and/or a portion of medical practice management system 54. Alternatively, information management process 10 may be a standalone application/applet that is configured to interact with medical practice management system 54.

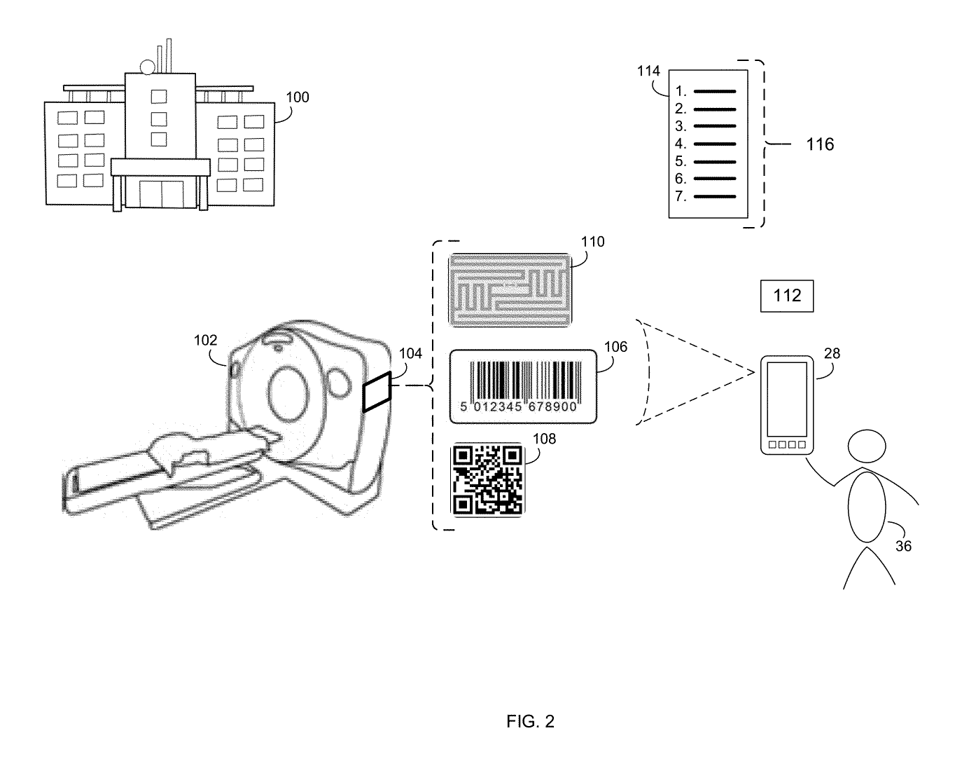

Assume for illustrative purposes that user 36 is a medical service technician. Referring also to FIG. 2, assume that user 36 arrives at medical facility 100 to perform maintenance on and/or repair medical device 102. Examples of medical device 102 may include but are not limited to: an ultrasound system, an x-ray system, a CAT scan system, an MRI system and a dialysis system. Further, assume that there are many variants of each type of system and that user 36 provides service to multiple medical facilities. Therefore, user 36 may not be readily familiar with the maintenance/repair procedures for each variant of each type of system.

Affixed to medical device 102 may be scannable tag 104, examples of which may include but are not limited to: an optically scannable tag and an electronically scannable tag. For example and if an optically scannable tag, scannable tag 104 may include e.g., bar code 106 and QR code 108 that may be readable by an optical scanning device (e.g., client electronic devices 28). Alternatively and if an electronically readable tag, scannable tag 104 may include e.g., RFID (i.e., Radio Frequency IDentification) tag 110 or an NFC (Near Field Communication) tag that may be energized by an electrical scanning device (e.g., client electronic devices 28). Regardless of whether scannable tag 104 is an optically scannable tag or an electronically scannable tag, scannable tag 104 may include unique identifying indicia that uniquely identifies medical device 102. For example, bar code 106 and/or QR code 108 may each be a unique optical code (and, therefore, may be uniquely identifiable). Further, RFID tag 110 or an NFC tag may be encoded with a unique identifier (and, therefore, may be uniquely identifiable).

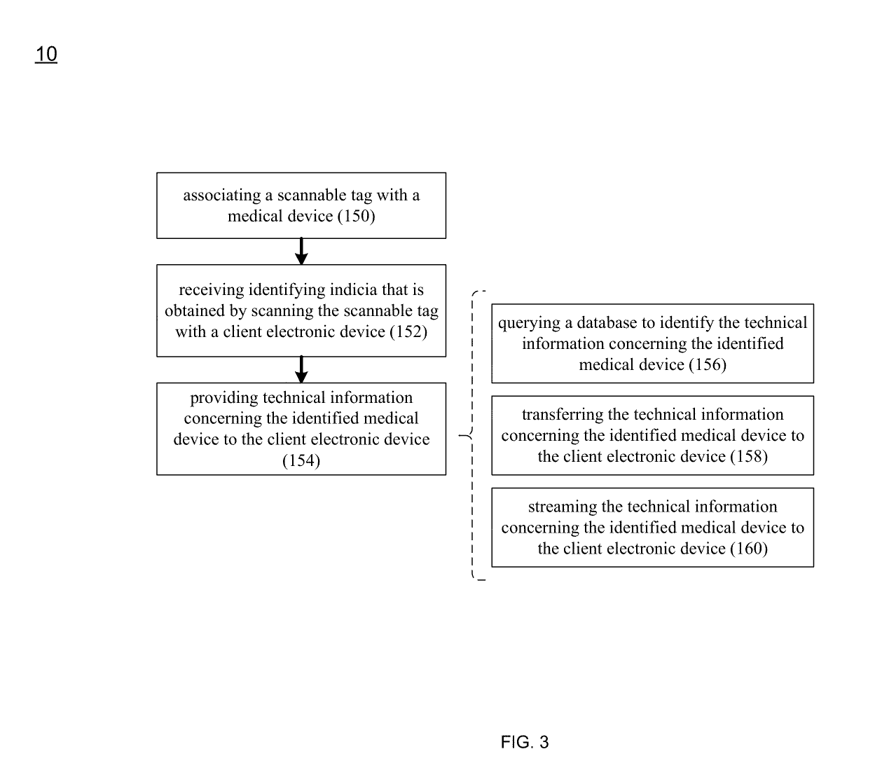

Referring also to FIG. 3, information management process 10 may associate 150 e.g., scannable tag 104 with e.g., medical device 102. As discussed above, each scannable tag (e.g., scannable tag 104) may be uniquely identifiable. Accordingly, information management process 10 may associate 150 the unique identifying indicia included within e.g., scannable tag 104 with medical device 102. Therefore, in the event that scannable tag 104 (which is attached to medical device 102) is scanned by e.g., client electronic device 28, medical device 102 may be identified.

Assume for illustrative purposes that client electronic device 28 may be configured to read scannable tag 104. Accordingly, if scannable tag 104 is an optically scannable tag, client electronic device 28 may include the required optical & electronic componentry to read (optically) scannable tag 104. Additionally, if scannable tag 104 is an electronically scannable tag, client electronic device 28 may include the required RF & electronic componentry to read (electronically) scannable tag 104.

Continuing with the above-stated example, assume that user 36 wishes to obtain technical information on medical device 102. Accordingly user 36 may scan scannable tag 104 using client electronic device 28, extracting the above-described identifying indicia (e.g., identifying indicia 112) from scannable tag 104. Identifying indicia 112 may be provided to information management process 10 via wireless communication channel 44 established between client electronic device 28 and cellular network/bridge 48, which is shown directly coupled to network 14.

Information management process 10 may receive 152 identifying indicia 112 that is obtained by scanning scannable tag 104 with client electronic device 28, thus defining an identified medical device (since each scannable tag 104 is unique, obtaining identifying indicia 112 may uniquely identify medical device 102). Information management process 10 may provide 154 technical information 56 (FIG. 1) concerning the identified medical device (i.e., medical device 102) to client electronic device 28.

Examples of technical information 56 may include but are not limited to one or more of:
an instructional video concerning the medical device that is renderable on client electronic device 28.
text-based information concerning the medical device that is renderable on client electronic device 28.
graphical information concerning the medical device that is renderable on client electronic device 28.

For example, upon scanning scannable tag 104, information management process 10 may render on client electronic device 28 a menu 114 that includes e.g., plurality of links 116 that may be e.g., linked to the various pieces of technical information 56. For example, one or more of links 116 may locate instructional videos concerning the maintenance, repair and/or usage of medical device 102, one or more of links 116 may locate text-based information concerning the maintenance, repair and/or usage of medical device 102, and/or one or more of links 116 may locate graphical information (e.g., photographs or instructional/technical drawings) concerning the maintenance, repair and/or usage of medical device 102

When providing 154 technical information 56 concerning the identified medical device (i.e., medical device 102), information management process 10 may query 156 a database (e.g., database 58) to identify technical information 56 concerning the identified medical device (i.e., medical device 102).

When providing 154 technical information 56 concerning the identified medical device (i.e., medical device 102), information management process 10 may transfer 158 technical information 56 concerning the identified medical device (i.e., medical device 102) to client electronic device 28, thus maintaining a local copy of technical information 56 on client electronic device 28.

When providing 154 technical information 56 concerning the identified medical device (i.e., medical device 102), information management process 10 may stream 160 technical information 56 concerning the identified medical device (i.e., medical device 102) to client electronic device 28.

While information management process 10 is described above as identifying medical devices (e.g., medical device 104) via the scanning of scannable tag 104 and providing technical information 56 concerning this medical device (e.g., medical device 102), other configurations are possible and are considered to be within the scope of this disclosure. For example, information management process 10 may also be configured to: provide topic-specific information concerning the performance of various medical procedures; document the performance of these various medical procedures; and provide various levels of reminders concerning the same.

For example, assume that user 40 is a medical professional (e.g., a nurse) within medical facility 100. For example, user 40 may be a floor nurse that performs medical procedures on patients that are admitted to medical facility 100. Alternatively/additionally, user 40 may be a travelling nurse that travels to perform these medical procedures at the homes of the patients that are at home convalescing. Examples of these medical procedures may include but are not limited to: the inspection and/or cleaning of a wound; the changing of a dressing of the wound, the inspection and/or changing of IV lines, the inspection and/or changing of catheters, the inspection and/or changing of PICC lines, and the ingestion of medicine/pills by a patient.

For the following example, the medical procedure described is going to concern the changing of a healthcare consumable, namely a wound dressing. However, this is for illustrative purposes only and is not intended to be a limitation of this disclosure, as other configurations are possible. Accordingly, the medical procedure being performed may also concern e.g., the inspection and/or changing of IV lines, the inspection and/or changing of catheters, the inspection and/or changing of PICC lines, and the ingestion of medicine/pills by a patient.

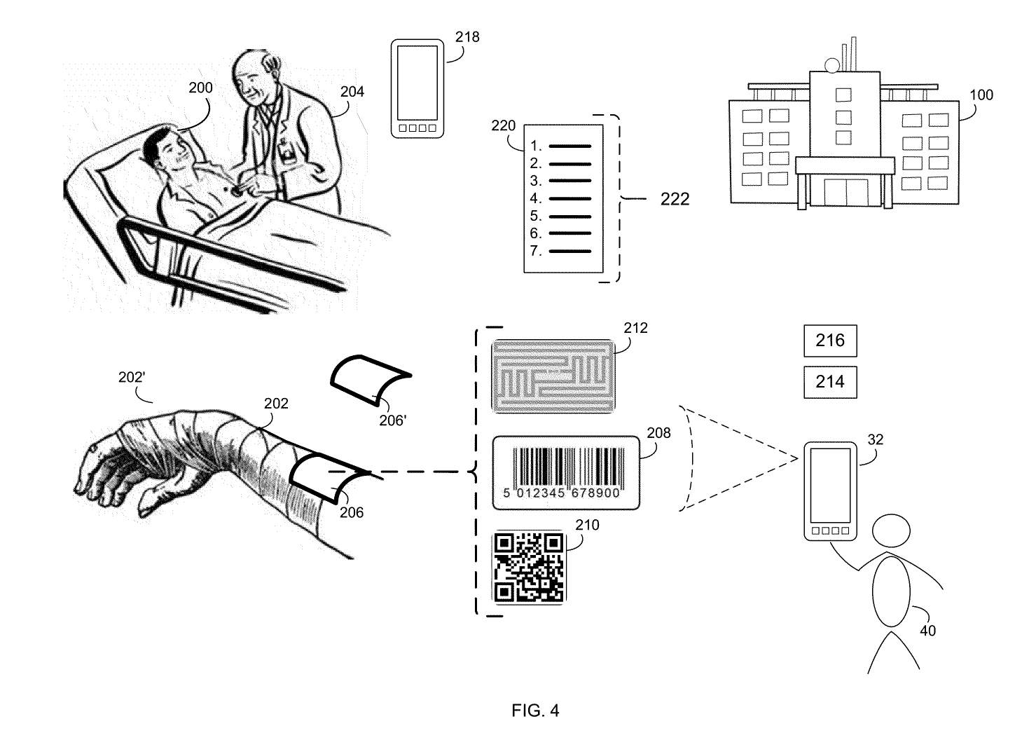

Referring also to FIG. 4, assume that patient 200 is a patient within medical facility 100. Further, assume that (for this example) patient 200 has a medical condition that complicates the healing of wounds. Further assume that patient 200 has a wound that is covered by wound dressing 202, wherein the doctor (e.g., doctor 204) treating patient 200 requires that wound dressing 202 be changed every 12 hours (to monitor how well the wound is healing and to reduce the chance of infection).

Affixed to wound dressing 202 may be scannable tag 206, examples of which may include but are not limited to: an optically scannable tag and an electronically scannable tag. As discussed above and if an optically scannable tag, scannable tag 206 may include e.g., bar code 208 and QR code 210 that may be readable by an optical scanning device (e.g., client electronic devices 32). Alternatively and if an electronically readable tag, scannable tag 206 may include e.g., RFID tag 212 or an NFC (Near Field Communication) tag that may be energized by an electrical scanning device (e.g., client electronic devices 32). As discussed above, scannable tag 206 may include unique identifying indicia that uniquely identifies wound dressing 202, wherein bar code 208 and/or QR code 210 may each be a unique optical code (and, therefore, may be uniquely identifiable) and RFID tag 212 or an NFC tag may be encoded with a unique identifier (and, therefore, may be uniquely identifiable).

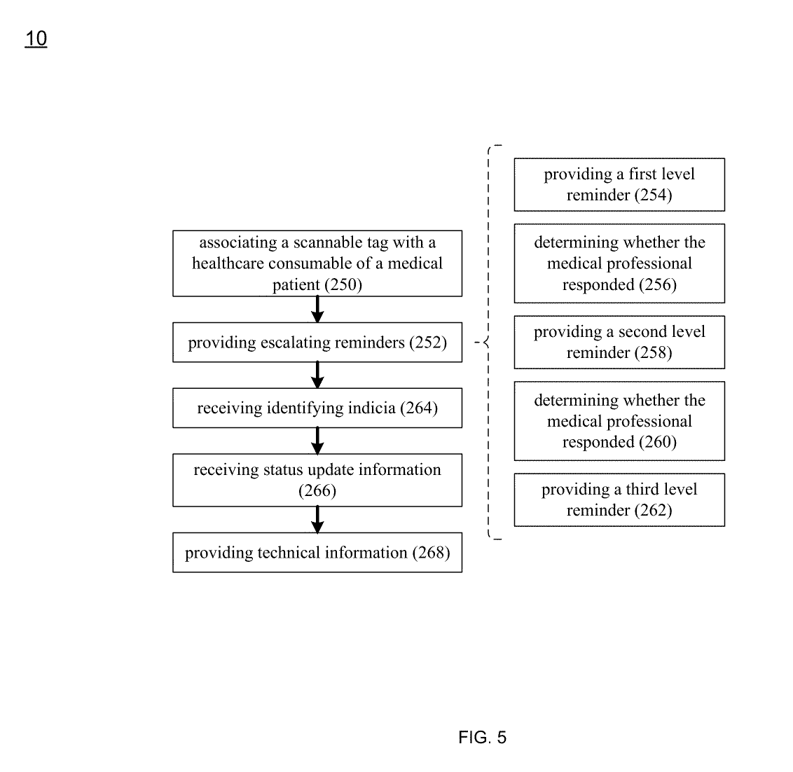

Referring also to FIG. 5, information management process 10 may associate 250 e.g., scannable tag 206 with a healthcare consumable (e.g., wound dressing 202) of medical patient 200. As discussed above, each scannable tag (e.g., scannable tag 206) may be uniquely identifiable. Accordingly, information management process 10 may associate 250 the unique identifying indicia included within e.g., scannable tag 206 with the healthcare consumable (namely wound dressing 202). Therefore, in the event that scannable tag 206 (which is attached to wound dressing 202) is scanned by e.g., client electronic device 32, wound dressing 202 may be identified.

Assume for illustrative purposes that client electronic device 32 may be configured to read scannable tag 206. Accordingly, if scannable tag 206 is an optically scannable tag, client electronic device 32 may include the required optical & electronic componentry to read (optically) scannable tag 206. Additionally, if scannable tag 206 is an electronically scannable tag, client electronic device 32 may include the required RF & electronic componentry to read (electronically) scannable tag 206.

Information management process 10 may provide 252 escalating reminders 60 (FIG. 1) to a medical professional (e.g., user 40) concerning the healthcare consumable (namely wound dressing 202). Escalating reminders 60 may concern a medical procedure to be performed on the healthcare consumable (e.g., wound dressing 202) by the medical professional (e.g., user 40). As discussed above, the doctor (e.g., doctor 204) treating patient 200 may require wound dressing 202 to be changed every 12 hours (to monitor how well the wound is healing and to reduce the chance of infection). Accordingly, escalating reminders 60 may concern (and effectuate) the changing of wound dressing 202 by user 40 at the intervals defined by doctor 204. Examples of escalating reminders 60 may include but are not limited to one or more of: a text message reminder (e.g., a text message sent to client electronic device 32); a voice call reminder (e.g., an automated, text-to-speech voice call made to client electronic device 32); an email reminder (e.g., a email message sent to client electronic device 32); and a social network reminder (e.g., a direct message sent to user 40 via e.g., Twitter™ or Facebook™).

When providing 252 escalating reminders 60, these reminders may be provided 252 at predefined intervals. For example, assume that doctor 204 would like wound dressing 202 to be changed at 9:00 a.m. and 9:00 p.m. every day (thus, at 12 hour intervals). Accordingly and for illustrative purposes, information management process 10 may be configured to provide 252 three escalating reminders 60, one reminder fifteen minutes before the deadline, a first follow up reminder thirty minutes after the deadline and, and a second follow up reminder ninety minutes after the deadline. The particular timing and quantity of these reminders (in this example, three reminders) may be defined by e.g., doctor 204 using information management process 10 or the administrator of information management process 10. As will be discussed below in greater detail, escalating reminders 60 may have escalating levels of urgency and may be provided 252 to different lists of recipients.

Continuing with the above-stated example, assume that for any of the deadlines (9:00 a.m. and 9:00 p.m. every day), information management process 10 may provide 252 the above-described three reminders. For example and when providing 252 escalating reminders 60 to the medical professional (e.g., user 40) for e.g., one of the 9:00 a.m. deadlines, information management process 10 may provide 254 a first level reminder (of escalating reminder 60) to the medical professional (e.g., user 40) at 8:45 a.m. As discussed above, escalating reminders 60 may have escalating levels of urgency and may be provided 252 to different lists of recipients. As this is the first level reminder, it may only be directed to user 40 and may have a low level of urgency, simply reminding user 40 of the upcoming 9:00 a.m. deadline for the changing of wound dressing 202.

Information management process 10 may determine 256 whether the medical professional (e.g., user 40) responded to the above-described first level reminder. As will be discussed below in greater detail, an example of such a response may include user 40 confirming/proving that wound dressing 202 was changed. If the medical professional (e.g., user 40) did not respond to the above-described first level reminder, information management process 10 may provide 258 a second level reminder (of escalating reminder 60) to the medical professional (e.g., user 40) at 9:30 a.m. As discussed above, escalating reminders 60 may have escalating levels of urgency and may be provided 252 to different lists of recipients. As this is the second level reminder, it may be directed to user 40 and a supervisor of user 40 (e.g., user 42, the shift supervisor) and may have an elevated level of urgency, notifying user 40 that the 9:00 a.m. deadline for the changing of wound dressing 202 has passed and asking them to perform the medical procedure ASAP.

Information management process 10 may determine 260 whether the medical professional (e.g., user 40) responded to the above-described second level reminder. Again, an example of such a response may include user 40 confirming/proving that (in this example) wound dressing 202 was changed. If the medical professional (e.g., user 40) did not respond to the second level reminder, information management process 10 may provide 262 a third level reminder (of escalating reminder 60) to the medical professional (e.g., user 40) at 10:30 a.m. As this is the third level reminder, it may be directed to user 40, a supervisor of user 40 (e.g., user 42, the shift supervisor), and doctor 202 and may have a high level of urgency, notifying user 40 that the 9:00 a.m. deadline for the changing of wound dressing 202 has passed some time ago and instructing them to perform the medical procedure immediately.

Continuing with the above-stated example, assume that user 40 reviews one of the reminders described above and proceeds to the room of patient 200 to perform the required medical procedure (e.g., changing wound dressing 202). Upon arriving at the patient's room, user 40 may scan scannable tag 206 using client electronic device 32, extracting the above-described identifying indicia (e.g., identifying indicia 214) from scannable tag 206. Identifying indicia 214 may be provided to information management process 10 via wireless communication channel 50 established between client electronic device 32 and wireless access point (i.e., WAP) 52, which is shown directly coupled to network 14.

Information management process 10 may receive 264 identifying indicia 214 that is obtained by the medical professional (e.g., user 40) scanning scannable tag 206 with client electronic device 32, thus defining (in this example) an identified wound dressing (since each scannable tag 206 is unique, obtaining identifying indicia 214 may uniquely identify wound dressing 202).

User 40 may then proceed to perform the related medical procedure, namely (and in this example) changing wound dressing 202 and cleaning the underlying wound. User 40 may also generate (on client electronic device 32) status update information 216 concerning this medical procedure (e.g., the changing of wound dressing 202) and may provide status update information 216 to information management process 10.

Examples of status update information 216 may include but is not limited to one or more of: a task completion confirmation concerning (in this example) the identified wound dressing (e.g., confirming that wound dressing 202 was indeed changed); a pain assessment concerning (in this example) the identified wound dressing (e.g., as reported/defined by patient 200); and visual information concerning (in this example) the identified wound dressing (e.g., a photograph of the changed wound dressing (not shown) or a photograph of the wound itself).

Information management process 10 may receive 266 status update information 216 that concerns (in this example) the identified wound dressing (e.g., wound dressing 202) from client electronic device 32. Information management process 10 may then use some or all of the information included within status update information 216 to update database 58 for audit/compliance purposes (e.g., to illustrate/document compliance with: the procedures of medical facility 100; the requirements of a health insurance provider; the requirements of various healthcare laws, etc.).

Once wound dressing 202 has been replaced (with wound dressing 202′), user 40 may apply a new scannable tag (e.g., scannable tag 206′) to the new wound dressing (e.g., wound dressing 202′). Additionally, user 40 may then scan the new scannable tag (e.g., scannable tag 206′) to associate 250 scannable tag 206′ with wound dressing 202′ on medical patient 200.

While the previous example concerned the user (e.g., user 40) of information management process 10 being a medical professional (e.g., a nurse) that is performing a medical procedure (e.g., changing wound dressing 202) for a patient (e.g., patient 200), this is for illustrative purposes only and is not intended to be a limitation of this disclosure, as other configurations are possible. For example, the user of information management process 10 may be the actual patient (e.g., patient 202) and the medical procedure (e.g., changing wound dressing 202) may be a procedure that the user (e.g., patient 202) performs on themself.

Assume for this example, that patient 202 has been released from medical facility 100. However, assume that wound dressing 202 still needs to be changed every twelve hours. Accordingly, information management process 10 may be configured for use by non-medical professionals (e.g., patient 200) and may operate in the same manner described above (e.g., providing 252 escalating reminders 60, receiving 264 identifying indicia 214, and receiving 266 status update information 216). However and unlike medical professionals (e.g., user 40), patient 200 may be unfamiliar with the appropriate procedures for performing the required medical procedure (e.g., changing wound dressing 202).

Accordingly, information management process 10 may provide 268 technical information 62 concerning (in this example) the identified wound dressing (e.g., wound dressing 202) to client electronic device 218 (e.g., a smartphone/tablet that is owned by/provided to patient 200).

Examples of technical information 62 may include but are not limited to one or more of:
an instructional video concerning (in this example) the wound dressing that is renderable on client electronic device 218.
text-based information concerning (in this example) the wound dressing that is renderable on client electronic device 218.
graphical information concerning (in this example) the wound dressing that is renderable on client electronic device 218.

For example, upon scanning scannable tag 206, information management process 10 may render on client electronic device 218 a menu 220 that includes e.g., plurality of links 222 that may be e g , linked to the various pieces of technical information 62. For example, one or more of links 222 may locate instructional videos concerning the inspection of a wound/the cleaning of a wound/the changing of a dressing of a wound; one or more of links 222 may locate text-based information concerning the inspection of a wound/the cleaning of a wound/the changing of a dressing of a wound; and/or one or more of links 222 may locate graphical information (e.g., photographs or instructional/illustrative drawings) concerning the inspection of a wound/the cleaning of a wound/the changing of a dressing of a wound.

When providing 268 technical information 62 concerning wound dressing 202, information management process 10 may query a database (e.g., database 58) to identify technical information 62 concerning (in this example) wound dressing 202 and may transfer technical information 62 concerning wound dressing 202 to client electronic device 218 (in the form of a media stream or as a file transfer).

As stated above, the medical procedure described above concerned the changing of a wound dressing. However, this is for illustrative purposes only and is not intended to be a limitation of this disclosure, as other configurations are possible. Accordingly, the medical procedure being performed may also concern any other healthcare consumables, such as the inspection and/or changing of IV lines, the inspection and/or changing of catheters, the inspection and/or changing of PICC lines, and the ingestion of medicine/pills by a patient.

Therefore, information management process 10 may be equally utilized to monitor the inspection and/or changing of IV lines, the inspection and/or changing of catheters, the inspection and/or changing of PICC lines, and the ingestion of medicine/ pills by a patient. Accordingly, scannable tags may be applied to various healthcare consumables, such as IV lines, catheters, PICC lines, and medicine/pills bottles for scanning and identification by information management process 10. Information management process 10 may provide the above-described reminders concerning these healthcare consumables and provide technical information concerning the same. Further, information management process 10 may ensure the performance of medical procedures concerning these healthcare consumables, such as the changing of IV lines, the replacement of a catheter, the changing of PICC lines, and the taking of medicine/pills. Accordingly, medical professionals or the patients may be required to scan the scannable tags applied to these healthcare consumables, perform the appropriate medical procedure, and confirm the same (via messages or photographs),

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing system, the computer-implemented method comprising:
associating a scannable tag with a healthcare consumable of a medical patient;
providing escalating reminders to a medical professional, the escalating reminders concerning a medical procedure to be performed on the healthcare consumable by the medical professional;
receiving identifying indicia that is obtained by the medical professional scanning the scannable tag with a client electronic device, thus defining an identified healthcare consumable; and
receiving status update information that concerns the identified healthcare consumable from the client electronic device.

2. The computer-implemented method of claim 1 wherein the status update information includes one or more of:
a task completion confirmation concerning the identified healthcare consumable;
a pain assessment concerning the identified healthcare consumable; and
visual information concerning the identified healthcare consumable.

3. The computer-implemented method of claim 1 wherein providing escalating reminders to a medical professional includes:
providing a first level reminder to the medical professional;
determining whether the medical professional responded to the first level reminder; and
if the medical professional did not respond to the first level reminder, providing a second level reminder to the medical professional.

4. The computer-implemented method of claim 3 wherein providing escalating reminders to a medical professional further includes:
determining whether the medical professional responded to the second level reminder; and
if the medical professional did not respond to the second level reminder, providing a third level reminder to the medical professional.

5. The computer-implemented method of claim 4 wherein:
the first level reminder has a first level of urgency and involves a first list of recipients;
the second level reminder has a second level of urgency and involves a second list of recipients; and
the third level reminder has a third level of urgency and involves a third list of recipients.

6. The computer-implemented method of claim 1 wherein the escalating reminders have escalating levels of urgency.

7. The computer-implemented method of claim 1 wherein the scannable tag includes one or more of:
an optically scannable tag; and
an electronically scannable tag.

8. A computer program product residing on a computer readable medium having a plurality of instructions stored thereon which, when executed by a processor, cause the processor to perform operations comprising:
associating a scannable tag with a healthcare consumable of a medical patient;
providing escalating reminders to a medical professional, the escalating reminders concerning a medical procedure to be performed on the healthcare consumable by the medical professional;
receiving identifying indicia that is obtained by the medical professional scanning the scannable tag with a client electronic device, thus defining an identified healthcare consumable; and
receiving status update information that concerns the identified healthcare consumable from the client electronic device.

9. The computer-implemented method of claim 8 wherein the status update information includes one or more of:
a task completion confirmation concerning the identified healthcare consumable;
a pain assessment concerning the identified healthcare consumable; and
visual information concerning the identified healthcare consumable.

10. The computer-implemented method of claim 8 wherein providing escalating reminders to a medical professional includes:
providing a first level reminder to the medical professional;
determining whether the medical professional responded to the first level reminder; and
if the medical professional did not respond to the first level reminder,
providing a second level reminder to the medical professional.

11. The computer-implemented method of claim 10 wherein providing escalating reminders to a medical professional further includes:
determining whether the medical professional responded to the second level reminder; and
if the medical professional did not respond to the second level reminder, providing a third level reminder to the medical professional.

12. The computer-implemented method of claim 11 wherein:
the first level reminder has a first level of urgency and involves a first list of recipients;
the second level reminder has a second level of urgency and involves a second list of recipients; and
the third level reminder has a third level of urgency and involves a third list of recipients.

13. The computer-implemented method of claim 8 wherein the escalating reminders have escalating levels of urgency.

14. The computer-implemented method of claim 8 wherein the scannable tag includes one or more of:
an optically scannable tag; and
an electronically scannable tag.

15. A computing system including a processor and memory configured to perform operations comprising:
associating a scannable tag with a healthcare consumable of a medical patient;
providing escalating reminders to a medical professional, the escalating reminders concerning a medical procedure to be performed on the healthcare consumable by the medical professional;
receiving identifying indicia that is obtained by the medical professional scanning the scannable tag with a client electronic device, thus defining an identified healthcare consumable; and
receiving status update information that concerns the identified healthcare consumable from the client electronic device.

16. The computer-implemented method of claim 15 wherein the status update information includes one or more of:
a task completion confirmation concerning the identified healthcare consumable;
a pain assessment concerning the identified healthcare consumable; and
visual information concerning the identified healthcare consumable.

17. The computer-implemented method of claim 15 wherein providing escalating reminders to a medical professional includes:
providing a first level reminder to the medical professional;
determining whether the medical professional responded to the first level reminder; and
if the medical professional did not respond to the first level reminder, providing a second level reminder to the medical professional.

18. The computer-implemented method of claim 17 wherein providing escalating reminders to a medical professional further includes:
determining whether the medical professional responded to the second level reminder; and
if the medical professional did not respond to the second level reminder, providing a third level reminder to the medical professional.

19. The computer-implemented method of claim 18 wherein:
the first level reminder has a first level of urgency and involves a first list of recipients;
the second level reminder has a second level of urgency and involves a second list of recipients; and
the third level reminder has a third level of urgency and involves a third list of recipients.

20. The computer-implemented method of claim 15 wherein the escalating reminders have escalating levels of urgency.

21. The computer-implemented method of claim 15 wherein the scannable tag includes one or more of:
an optically scannable tag; and
an electronically scannable tag.
